(19) United States
(12) Patent Application Publication
(10) Pub. No.: US 2017/0147187 A1
(43) Pub. Date: May 25, 2017

(54) TO-BE-SHARED INTERFACE PROCESSING METHOD, AND TERMINAL

(71) Applicant: Tencent Technology (Shenzhen) Company Limited, Shenzhen, Guangdong (CN)

(72) Inventors: Lu MU, Shenzhen (CN); Xiaoguang YAO, Shenzhen (CN); Fanfan WU, Shenzhen (CN); Liang FAN, Shenzhen (CN)

(73) Assignee: Tencent Technology (Shenzhen) Company Limited, Shenzhen, Guangdong (CN)

(21) Appl. No.: 15/310,359

(22) PCT Filed: May 12, 2015
(86) PCT No.: PCT/CN2015/078750

§ 371 Date: Nov. 10, 2016

(30) Foreign Application Priority Data
May 12, 2014 (CN) 201410198326.X

(51) Int. Cl. G06F 3/0484; G06F 9/44

(52) U.S. Cl. CPC G06F 3/04842; G06F 3/04847; G06F 9/4443

(57) ABSTRACT

Disclosed is a to-be-shared interface processing method, including: receiving a personalized setting instruction of a terminal in a first to-be-shared interface, and displaying a preset personalized setting interface according to the personalized setting instruction; determining, after a message indicating that a user completes content setting in the personalized setting interface is received, that the personalized setting interface in which content setting is completed is a second to-be-shared interface; and sharing, after a sharing instruction of the terminal is received, the second to-be-shared interface to a location specified by the user. According to the to-be-shared interface processing method provided in embodiments of the present invention, a user may set a to-be-shared interface, so as to improve to-be-shared content, and enrich the to-be-shared content, thereby improving intention of the user to share and interact, and finally increasing frequency of communication between the user and a game product.

### FIELD OF THE TECHNOLOGY

The present disclosure relates to the field of to-be-shared interface processing technologies, and in particular, to a to-be-shared interface processing method, and a terminal.

### BACKGROUND OF THE DISCLOSURE

Currently, some instant messaging tools, such as QQ and WeChat, all include some small games. A user may play a game such as Craz3 Match and War Planes in QQ or WeChat. After the game is ended, a picture of a score appears, the score and a small animal or a plane picture that is preset by a developer are in the picture, and the user may share the picture of the score to Moments or a friend by using QQ or WeChat.

During research and implementation of the existing technology, the inventor of the present disclosure finds that, currently, based on a game product of a social networking application, content proactively shared by a user is preset by a developer, and the user cannot perform user-defined modification or add other content, which leads to monotonous shared content and high repeatability, thereby lowering intention of the user to share and interact, and finally leading to a decrease of frequency of communication between the user and the game product.

### SUMMARY

Embodiments of the present invention provide a to-be-shared interface processing method, where a user may set a to-be-shared interface, so as to improve to-be-shared content, and enrich the to-be-shared content. The embodiments of the present invention further provide a corresponding terminal.

A first aspect of the present disclosure provides a to-be-shared interface processing method, including:

receiving a personalized setting instruction of a terminal in a first to-be-shared interface, and displaying a preset personalized setting interface according to the personalized setting instruction;

determining, after a message indicating that a user completes content setting in the personalized setting interface is received, that the personalized setting interface in which content setting is completed is a second to-be-shared interface; and

sharing, after a sharing instruction of the terminal is received, the second to-be-shared interface to a location specified by the user.

A second aspect of the present disclosure provides a terminal, including:

a receiving unit, configured to receive a personalized setting instruction of a terminal in a first to-be-shared interface;

a display unit, configured to display a preset personalized setting interface according to the personalized setting instruction received by the receiving unit, the receiving unit being further configured to receive a message indicating that a user completes content setting in the personalized setting interface;

a determining unit, configured to: after the receiving unit receives the message indicating that the user completes content setting in the personalized setting interface, determine that the personalized setting interface in which content setting is completed is a second to-be-shared interface,

the receiving unit being further configured to receive a sharing instruction of the terminal; and

a sharing unit, configured to: after the receiving unit receives the sharing instruction of the terminal, share the second to-be-shared interlace to a location specified by the user.

According to the embodiments of the present invention, a personalized setting instruction of a terminal is received in a first to-be-shared interface, and a preset personalized setting interface is displayed according to the personalized setting instruction; after a message indicating that a user completes content setting in the personalized setting interface is received, it is determined that the personalized setting interface in which content setting is completed is a second to-be-shared interface; and after a sharing instruction of the terminal is received, the second to-be-shared interface is shared to a location specified by the user. Compared with the existing technology in which a user cannot perform user-defined modification or add other content, which leads to monotonous content in a shared interface and high repeatability, according to the to-be-shared interface processing method provided in the embodiments of the present invention, the user may set a to-be-shared interface, so as to improve to-be-shared content, and enrich the to-be-shared content, thereby improving intention of the user to share and interact, and finally increasing frequency of communication between the user and a game product.

### BRIEF DESCRIPTION OF THE DRAWINGS

To describe the technical solutions according to the embodiments of the present invention more clearly, the accompanying drawings for describing the embodiments are introduced briefly in the following. Apparently, the accompanying drawings in the following description are only some embodiments of the present invention, and a person of ordinary skill in the art can derive other drawings from the accompanying drawings without creative efforts.

FIG. 1 is a schematic diagram of an embodiment of a to-be-shared interface processing method according to the embodiments of the present invention;

FIG. 2 is a schematic diagram of another embodiment of a to-be-shared interface processing method according to the embodiments of the present invention;

FIG. 3 is a schematic diagram of another embodiment of a to-be-shared interface processing method according to the embodiments of the present invention;

FIG. 4 is a schematic diagram of an embodiment of a terminal according to the embodiments of the present invention;

FIG. 5 is a schematic diagram of an embodiment of a terminal according to the embodiments of the present invention; and

FIG. 6 is a schematic diagram of an embodiment of a terminal according to the embodiments of the present invention.

### DESCRIPTION OF EMBODIMENTS

Embodiments of the present invention provide a to-be-shared interface processing method, where a user may set a to-be-shared interface, so as to improve to-be-shared content, and enrich the to-be-shared content. The embodiments of the present invention further provide a corresponding terminal. The following gives detailed descriptions separately.

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by persons skilled in the art based on the embodiments of the present invention without creative efforts shall fall within the protection scope of the present disclosure.

Referring to FIG. 1, an embodiment of a to-be-shared interface processing method provided in the embodiments of the present invention includes:

101: Receive a personalized setting instruction of a terminal in a first to-be-shared interface, and display a preset personalized setting interface according to the personalized setting instruction.

The first to-be-shared interface may be a to-be-shared interface generated after Craz3 Match is played, and the to-be-shared interface includes a preset icon of an animal and a score of this game.

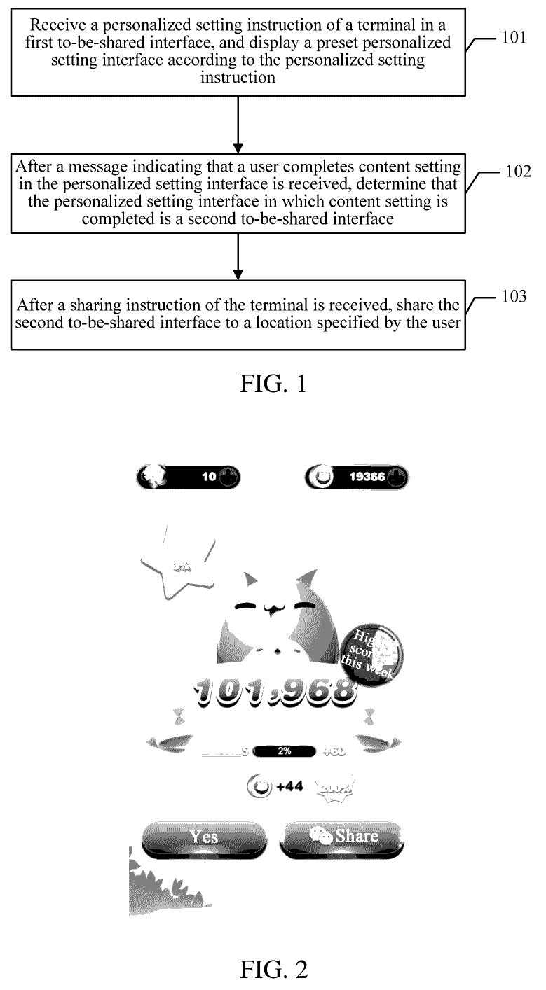

For example, FIG. 2 is the first to-be-shared interface generated after one game of Craz3 Match is played, and the first to-be-shared interface displays an icon of an animal, a score, and some other information.

FIG. 2 further displays two buttons: “Yes” and “Share”, the button “Yes” corresponds to some conventional procedures, for example, start a next game, or share to a friend and share to Moments.

The button “Share” corresponds to personalized setting procedures. If a user clicks the button “Share”, which is equivalent to the personalized setting instruction of the terminal, the terminal may display the personalized setting interface according to the personalized setting instruction.

Multiple personalized setting interfaces may be preset, for example, picture frame interfaces of different shapes, and background interfaces in different colors.

After the user selects a favorite setting interface from the multiple preset personalized setting interfaces, the terminal displays the personalized setting interface selected by the user.

The personalized setting interface is used for the user to perform personalized setting in the setting interface according to intention of the user.

102: After a message indicating that the user completes content setting in the personalized setting interface is received, determine that the personalized setting interface in which content setting is completed is a second to-be-shared interface.

After the user performs personalized setting the personalized setting interface according to the intention of the user, if satisfactory effects are achieved, the user may input, by clicking a use button in the interface, the message indicating that content setting is completed.

The terminal determines, according to the message indicating that content setting is completed, that the personalized setting interface in which the user completes content setting is the second to-be-shared interface.

103: After a sharing instruction of the terminal is received, share the second to-be-shared interface to a location specified by the user.

After the second to-be-shared interface is determined, the user may share the second to-be-shared interface to Moments or a friend, and the terminal may share the second to-be-shared interface to Moments or a friend according to an instruction of the user. The location specified by the user may be Moments or a friend.

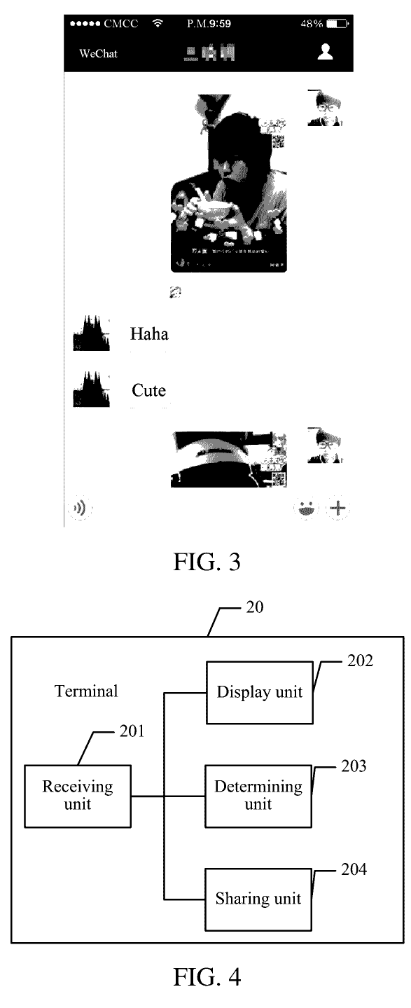

As shown in FIG. 3, the user shares the set second to-be-shared interface to a friend by using WeChat, and after viewing the second to-be-shared interface, the friend interacts with the user.

According to this embodiment of the present invention, a personalized setting instruction of a terminal is received in a first to-be-shared interface, and a preset personalized setting interface is displayed according to the personalized setting instruction; after a message indicating that a user completes content setting in the personalized setting interface is received, it is determined that the personalized setting interface in which content setting is completed is a second to-be-shared interface; and after a sharing instruction of the terminal is received, the second to-be-shared interface is shared to a location specified by the user. Compared with the existing technology in which a user cannot perform user-defined modification or add other content, which leads to monotonous content in a shared interface and high repeatability, according to the to-be-shared interface processing method provided in this embodiment of the present invention, the user may set a to-be-shared interface, so as to improve to-be-shared content, and enrich the to-be-shared content, thereby improving intention of the user to share and interact, and finally increasing frequency of communication between the user and a game product.

Optionally, based on the embodiment corresponding to FIG. 1, in another embodiment of the to-be-shared interface processing method provided in the embodiments of the present invention, after the displaying a preset personalized setting interface, the method may further include:

displaying a preset setting policy, and displaying, according to a setting policy selected by the user, an interface corresponding to the setting policy selected by the user; and

acquiring a picture that is determined by the user in the corresponding interface, and loading the picture to the personalized setting interface.

In this embodiment of the present invention, the preset setting policy may include at least one of indication information selected from an existing picture, photographing identifier information, and scribble input indication information.

Optionally, based on the optional embodiment corresponding to FIG. 1, in another embodiment of the to-be-shared interface processing method provided in the embodiments of the present invention, the setting policy is the indication information selected from the existing picture, and the displaying, according to a setting policy selected by the user, an interface corresponding to the setting policy selected by the user may include:

displaying an interface of the existing picture according to the indication information selected from the existing picture; and

the acquiring a picture that is determined by the user in the corresponding interface may include:

acquiring a picture that is selected by the user in the interface of the existing picture.

In this embodiment of the present invention, when the user needs to select a picture from the existing picture, the terminal may open an album, and display a picture in the album. After the user selects a picture, the terminal acquires the picture that is selected by the user from the album, and loads the picture to the personalized setting interface. For example, the user selects a self-portrait photograph of the user, and then may load the self-portrait photograph to the personalized setting interface. Certainly, the user may also select another picture.

Optionally, based on the optional embodiment corresponding to FIG. 1, in another embodiment of the to-be-shared interface processing method provided in the embodiments of the present invention, the setting policy is the photographing identifier information, and the displaying, according to a setting policy selected by the user, an interface corresponding to the setting policy selected by the user includes:

displaying a photographing interface according to the photographing identifier information selected by the user; and

the acquiring a picture that is determined by the user in the corresponding interface includes:

acquiring a picture that is obtained by photographing by the user in the photographing interface.

In this embodiment of the present invention, when the user needs to directly photograph, the photographing interface may be displayed, and then, after the user photographs, and determines that photographing does not need to be performed again, the picture that is obtained by photographing by the user in the photographing interface is acquired.

Optionally, based on the optional embodiment corresponding to FIG. 1, in another embodiment of the to-be-shared interface processing method provided in the embodiments of the present invention, the setting policy is the scribble input indication information, and the displaying, according to a setting policy selected by the user, an interface corresponding to the setting policy selected by the user may include:

displaying a scribble interface according to the scribble input indication information selected by the user; and

the acquiring a picture that is determined by the user in the corresponding interface may include:

acquiring a picture that is obtained by scribbling by the user in the scribble interface.

In this embodiment of the present invention, when the user needs to create a picture or writes some words, the picture or the words may all be input by using the scribble interface. Then, the terminal acquires the picture that is obtained by the user in the scribble interface.

Optionally, based on the embodiment or the optional embodiment corresponding to FIG. 1, in another embodiment of the to-be-shared interface processing method provided in the embodiments of the present invention, the displaying a preset personalized setting interface according to the personalized setting instruction may include:

displaying multiple preset personalized setting interfaces according to the personalized setting instruction; and

receiving an interface selection instruction of the terminal, and displaying a personalized setting interface that is selected by the user from the multiple preset personalized setting interfaces,

In this embodiment of the present invention, multiple personalized setting interfaces may be preset, for example, picture frame interfaces of different shapes, and background interfaces in different colors.

After the user selects a favorite setting interface from the multiple preset personalized setting interfaces, the terminal displays the personalized setting interface selected by the user.

The personalized setting interface is used for the user to perform personalized setting in the setting interface according to intention of the user.

Based on original fixed sharing, this embodiment of the present invention provides a user-defined sharing mode in which a player may photograph or use an existing photograph.

For a photographing function, when it is detected that a mobile phone of the user does not have a front-facing camera, a system automatically optimizes a function of using other photographing forms or prompting the user to invoke a locally stored picture.

This embodiment of the present invention further provides a picture beautification function, where the user may voluntarily select a picture frame, so as to beautify and attire a picture.

Referring to FIG. 4, an embodiment of a terminal provided by the embodiments of the present invention includes:

a receiving unit 201, configured to receive a personalized setting instruction of a terminal in a first to-be-shared interface;

a display unit 202, configured to display a preset personalized setting interface according to the personalized setting instruction received by the receiving unit 201, where

the receiving unit 201 is further configured to receive a message indicating that a user completes content setting in the personalized setting interface;

a determining unit 203, configured to: after the receiving unit 201 receives the message indicating that the user completes content setting in the personalized setting interface, determine that the personalized setting interface in which content setting is completed is a second to-be-shared interface, where

the receiving unit 201 is further configured to receive a sharing instruction of the terminal; and

a sharing unit 204, configured to: after the receiving unit 201 receives the sharing instruction of the terminal, share the second to-be-shared interface to a location specified by the user.

In this embodiment of the present invention, the receiving unit 201 receives a personalized setting instruction of a terminal in a first to-be-shared interface; the display unit 202 displays a preset personalized setting interface according to the personalized setting instruction received by the receiving unit 201, and the receiving unit 201 further receives a message indicating that a user completes content setting in the personalized setting interface; after the receiving unit 201 receives the message indicating that the user completes content setting in the personalized setting interface, the determining unit 203 determines that the personalized setting interface in which content setting is completed is a second to-be-shared interface, and the receiving unit 201 further receives a sharing instruction of the terminal; after the receiving unit 201 receives the sharing instruction of the terminal, the sharing unit 204 shares the second to-be-shared interface to a location specified by the user. Compared with the existing technology in which a user cannot perform user-defined modification or add other content, which leads to monotonous content in a shared interface and high repeatability, according to the terminal provided in this embodiment of the present invention, the user may set a to-be-shared interface, so as to improve to-be-shared content, and enrich the to-be-shared content, thereby improving intention of the user to share and interact, and finally increasing frequency of communication between the user and a game product.

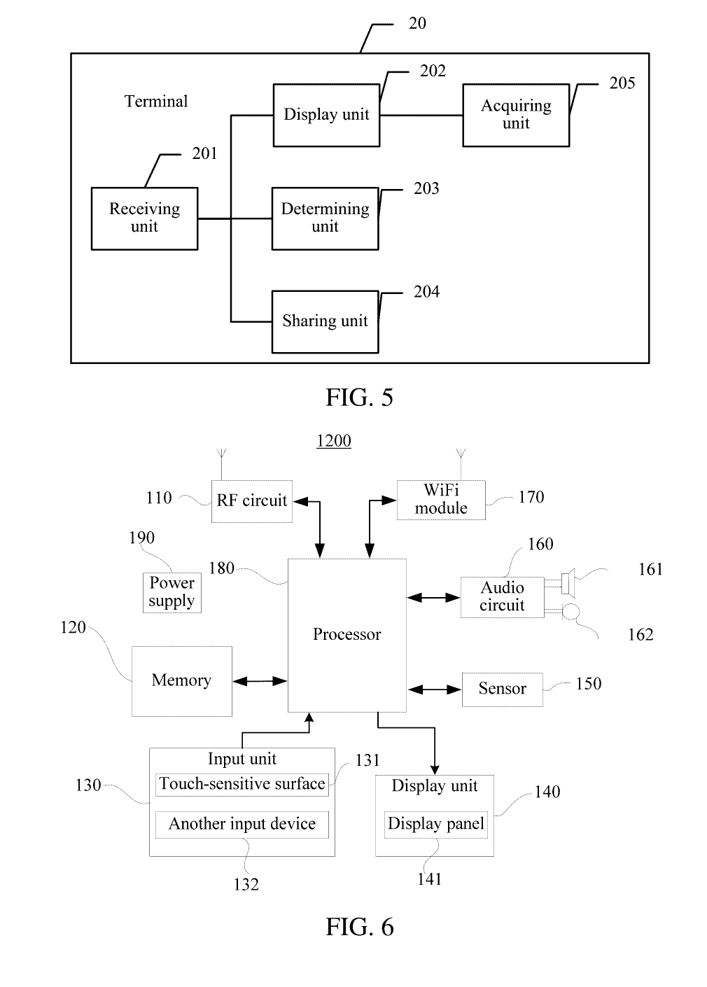

Optionally, based on the embodiment corresponding to FIG. 4, referring to FIG. 5, in another embodiment of the terminal provided in the embodiments of the present invention,

the display unit 202 is further configured to display a preset setting policy, and display, according to a setting policy selected by the user, an interface corresponding to the setting policy selected by the user: and

the terminal 20 further includes:

an acquiring unit 205, configured to acquire a picture that is determined by the user in the corresponding interface displayed by the display unit 202, and load the picture to the personalized setting interface.

Optionally, based on the embodiment corresponding to FIG. 5, in another embodiment of the terminal provided in the embodiments of the present invention, the setting policy is indication information selected from an existing picture, and

the display unit 202 is configured to display an interface of the existing re according to the indication information selected from the existing picture; and

the acquiring unit 205 is configured to acquire a picture that is selected by the user in the interface of the existing picture.

Optionally, based on the embodiment corresponding to FIG. 5, in another embodiment of the terminal provided in the embodiments of the present invention, the setting policy is photographing identifier information, and

the display unit 202 is configured to display a photographing interface according to the photographing identifier information selected by the user; and

the acquiring unit 205 is configured to acquire a picture that is obtained by photographing by the user in the photographing interface.

Optionally, based on the embodiment corresponding to FIG. 5, in another embodiment of the terminal provided in the embodiments of the present invention, the setting policy is scribble input indication information, and

the display unit 202 is configured to display a scribble interface according to the scribble input indication information selected by the user; and

the acquiring unit 205 is configured to acquire a picture that is obtained by scribbling by the user in the scribble interface.

Optionally, based on any embodiment corresponding to FIG. 4 or FIG. 5, in another embodiment of the terminal provided in the embodiments of the present invention,

the display unit 202 is configured to display multiple preset personalized setting interfaces according to the personalized setting instruction;

the receiving unit 201 is further configured to receive an interface selection instruction of the terminal; and

the display unit 202 is configured to display, according to the interface selection instruction of the terminal, a personalized setting interface that is selected by the user from the multiple preset personalized setting interfaces.

Refer to FIG. 6, which is a schematic structural diagram of a terminal involved in an embodiment of the present invention. The terminal may be configured to execute the to-be-shared interface processing method provided in the foregoing embodiments. Specifically:

The terminal 1200 may include components such as a radio frequency (RF) circuit 110, a memory 120 including one or more computer readable storage media, an input unit 130, a display unit 140, a sensor 150, an audio circuit 160, a wireless fidelity (WiFi) module 170, a processor 180 including one or more processing cores, and a power supply 190. A person skilled in the art may understand that the structure of the terminal shown in FIG. 6 does not constitute any limitation to the terminal, and the terminal may include more components or fewer components than those shown in the figure, or some components may be combined, or a different component deployment may be used.

The RF circuit 110 may be configured to receive and send a signal during an information receiving and sending process or a call process. Specifically, after the RF circuit receives downlink information from a base station, the RI circuit delivers the downlink information to one or more processors 180 for processing, and sends related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 110 may also communicate with a network and another device through wireless communication. The wireless communication may use any communications standard or protocol, which includes, but is not limited to, Global System for Mobile Communications (GSM), a General Packet Radio Service (GPRS), Code Division Multiple Access (CDMA), Wideband Code Division Multiple Access (WCDMA), Long Term Evolution (LTE), e-mail, and Short Messaging Service (SMS).

The memory 120 may be configured to store a software program and module. The processor 180 runs the software program and module that are stored in the memory 120, to implement various functional applications and data processing. The memory 120 may mainly include a program storage area and a data storage area. The program storage area may store an operating system, an application program required by at least one function (such as a sound playback function and an image display function), and the like. The data storage area may store data (such as audio data and an address book) created according to use of the terminal 1200, and the like. In addition, the memory 120 may include a high speed random access memory, and may also include a non-volatile memory, such as at least one magnetic disk storage device, a flash memory, or another volatile solid storage device. Accordingly, the memory 120 may further include a memory controller, so that the processor 180 and the input unit 130 access the memory 120.

The input unit 130 may be configured to receive input digit or character information, and generate keyboard, mouse, joystick, optical, or track ball signal input related to the user setting and function control. Specifically, the input unit 130 may include a touch-sensitive surface 131 and another input device 132. The touch-sensitive surface 131 may also be referred to as a touch screen or a touch panel, and may collect a touch operation of a user on or near the touch-sensitive surface (such as an operation of a user on or near the touch-sensitive surface 131 by using any suitable object or attachment, such as a finger or a touch pen), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 180. Moreover, the touch controller can receive and execute a command sent from the processor 180. In addition, the touch-sensitive surface 131 may be implemented by using various types, such as a resistive type, a capacitance type, an infrared type, and a surface sound wave type. In addition to the touch sensitive surface 131, the input unit 130 may further include the another input device 132. Specifically, the another input device 132 may include, but is not limited to, one or more of a physical keyboard, a functional key (such as a volume control key or a switch key), a track ball, a mouse, and a joystick.

The display unit 140 may be configured to display information input by the terminal or information provided for the user, and various graphical user interfaces of the terminal 1200. The graphical user interfaces may be formed by a graph, a text, an icon, a video, and any combination thereof. The display unit 140 may include a display panel 141. Optionally, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine a type of a touch event. Then, the processor 180 provides corresponding visual output on the display panel 141 according to the type of the touch event. Although, in FIG. 6, the touch-sensitive surface 131 and the display panel 141 are used as two separate parts to implement input and output functions, in some embodiments, the touch-sensitive surface 131 and the display panel 141 may be integrated to implement the input and output functions.

The terminal 1200 may further include at least one sensor 150, such as an optical sensor, a motion sensor, and other sensors. Specifically, the optical sensor may include an ambient light sensor and a proximity sensor. The ambient light sensor may adjust luminance of the display panel 141 according to brightness of the ambient light. The proximity sensor may switch off the display panel 141 and/or backlight when the terminal 1200 is moved to the ear. As one type of motion sensor, a gravity acceleration sensor may detect magnitude of accelerations at various directions (which generally are triaxial), may detect magnitude and a direction of the gravity when static, and may be configured to identify an application of a mobile phone gesture (such as switchover between horizontal and vertical screens, a related game, and gesture calibration of a magnetometer), a related function of vibration identification (such as a pedometer and a knock). Other sensors, such as a gyroscope, a barometer, a hygrometer, a thermometer, and an infrared sensor, which may be configured in the terminal 1200 are not further described herein.

The audio circuit 160, a loudspeaker 161, and a microphone 162 may provide audio interfaces between the user and the terminal 1200. The audio circuit 160 may transmit, to the loudspeaker 161, a received electric signal converted from received audio data. The loudspeaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal by using the RF circuit 110, or outputs the audio data to the memory 120 for further processing. The audio circuit 160 may further include an earplug jack, so as to provide communication between a peripheral earphone and the terminal 1200.

WiFi belongs to a short distance wireless transmission technology. The terminal 1200 may help, by using the WiFi module 170, the user to receive and send an e-mail, browse a webpage, access stream media, and the like, which provides wireless broadband Internet access for the user. Although FIG. 6 shows the WiFi module 170, it may be understood that, the WiFi module 170 does not belong to a necessary constitution of the terminal 1200, and can be ignored according to demands without changing the scope of the essence of the present disclosure.

The processor 180 is a control center of the terminal 1200, and connects to various parts of a mobile phone by using various interlaces and lines. By running or executing the software program and/or module stored in the memory 120, and invoking data stored in the memory 120, the processor 180 performs various functions and data processing of the terminal 1200, thereby performing overall monitoring on the mobile phone. Optionally, the processor 180 may include one or more processing cores. Preferably, the processor 180 may integrate an application processor and a modem. The application processor mainly processes an operating system, a user interface, an application program, and the like. The modem mainly processes wireless communication. It may be understood that, the foregoing modern may also not be integrated into the processor 180.

The terminal 1200 further includes the power supply 190 (such as a battery) for supplying power to the components. Preferably, the power supply may logically connect to the processor 180 by using a power supply management system, thereby implementing functions, such as charging, discharging, and power consumption management, by using the power supply management system. The power supply 190 may further include any component, such as one or more direct current or alternate current power supplies, a re-charging system, a power supply fault detection circuit, a power supply converter or an inverter, and a power supply state indicator.

Although not shown in the figure, the terminal 1200 may further include a camera, a Bluetooth module, and the like, which are not further described herein. Specifically, in this embodiment, the display unit of the terminal is a touch screen display, and the terminal further includes a memory and one or more programs. The one or more programs are stored in the memory and configured to be executed by one or more processors. The one or more programs contain instructions used for implementing the following operations:

receiving a personalized setting instruction of a terminal in a first to-be-shared interface, and displaying a preset personalized setting interface according to the personalized setting instruction;

after a message indicating that a user completes content setting in the personalized setting interface is received, determining that the personalized setting interface in which content setting is completed is a second to-be-shared interface; and

sharing, after a sharing instruction of the terminal is received, the second to-be-shared interface to a location specified by the user.

Assuming that the foregoing is a first possible implementation manner, in a second possible implementation manner provided based on the first possible implementation manner, the memory of the terminal further includes instructions used for implementing the following operations:

displaying a preset setting policy, and displaying, according to a setting policy selected by the user, an interface corresponding to the setting policy selected by the user; and

acquiring a picture that is determined by the user in the corresponding interface, and loading the picture to the personalized setting interface.

In a third possible implementation manner provided based on the second possible implementation manner, the memory of the terminal further includes instructions used for implementing the following operations: the setting policy being indication information selected from an existing picture, and

displaying an interface of the existing picture according to the indication information selected from the existing picture; and

acquiring a picture that is selected by the user in the interface of the existing picture.

In a fourth possible implementation manner provided based on the second possible implementation manner, the memory of the terminal further includes instructions used for implementing the following operations: the setting policy being photographing identifier information, and

displaying a photographing interface according to the photographing identifier information selected by the user; and

acquiring a picture that is obtained by photographing by the user in the photographing interface.

In a fifth possible implementation manner provided based on the second possible implementation manner, the memory of the terminal further includes instructions used for implementing the following operations: the setting policy being scribble input indication information, and

displaying a scribble interface according to the scribble input indication information selected by the user; and

acquiring a picture that is obtained by scribbling by the user in the scribble interface.

In a sixth possible implementation manner provided based on any one of the first to the fifth possible implementation manners, the memory of the terminal further includes instructions used for implementing the following operations:

displaying multiple preset personalized setting interfaces according to the personalized setting instruction; and

receiving an interface selection instruction of the terminal, and displaying a personalized setting interface that is selected by the user from the multiple preset personalized setting interfaces.

To sum up, according to the terminal provided in this embodiment, a personalized setting instruction of a terminal is received in a first to-be-shared interface, and a preset personalized setting interface is displayed according to the personalized setting instruction; after a message indicating that a user completes content setting in the personalized setting interface is received, it is determined that the personalized setting interface in which content setting is completed is a second to-be-shared interface; and after a sharing instruction of the terminal is received, the second to-be-shared interface is shared to a location specified by the user. Compared with the existing technology in which a user cannot perform user-defined modification or add other content, which leads to monotonous content in a shared interface and high repeatability, according to the to-be-shared interface processing method provided in the embodiments of the present invention, the user may set a to-be-shared interface, so as to improve to-be-shared content, and enrich the to-be-shared content, thereby improving intention of the user to share and interact, and finally increasing frequency of communication between the user and a game product.

As another aspect, still another embodiment of the present invention further provides a computer readable storage medium, and the computer readable storage medium may be a computer readable storage medium included in the memory in the foregoing embodiment, or may be a computer readable storage medium that independently exists and is not installed into a terminal. The computer readable storage medium stores one or more programs, the one or more programs are configured by one or more processors to perform a to-be-shared interface processing method, and the method includes:

receiving a personalized setting instruction of a terminal in a first to-be-shared interface, and displaying a preset personalized setting interface according to the personalized setting instruction;

after a message indicating that a user completes content setting in the personalized setting interface is received, determining that the personalized setting interface in which content setting is completed is a second to-be-shared interface; and

after a sharing instruction of the terminal is received, sharing the second to-be-shared interlace to a location specified by the user.

Assuming the foregoing is a first possible implementation manner, in a second possible implementation manner provided based on the first possible implementation manner, after the displaying a preset personalized setting interface, the method further includes:

displaying a preset setting policy, and displaying, according to a setting policy selected by the user, an interface corresponding to the setting policy selected by the user; and

acquiring a picture that is determined by the user in the corresponding interface, and loading the picture to the personalized setting interface.

In a third possible implementation manner provided based on the second possible implementation manner, the setting policy is indication information selected from an existing picture, and the displaying, according to a setting policy selected by the user, an interface corresponding to the setting policy selected by the user includes:

displaying an interface of the existing picture according to the indication information selected from the existing picture; and

the acquiring a picture that is determined by the user in the corresponding interface includes:

acquiring a picture that is selected by the user in the interface of the existing picture.

In a fourth possible implementation manner provided based on the second possible implementation manner, the setting policy is photographing identifier information, and the displaying, according to a setting policy selected by the user, an interface corresponding to the setting policy selected by the user includes:

displaying a photographing interface according to the photographing identifier information selected by the user; and

the acquiring a picture that is determined by the user in the corresponding interface includes:

acquiring a picture that is obtained by photographing by the user in the photographing interface.

In a fifth possible implementation manner provided based on the second possible implementation manner, the setting policy is scribble input indication information, and the displaying, according to a setting policy selected by the user, an interface corresponding to the setting policy selected by the user includes:

displaying a scribble interface according to the scribble input indication information selected by the user; and

the acquiring a picture that is determined by the user in the corresponding interface includes:

acquiring a picture that is obtained by scribbling by the user in the scribble interface.

In a sixth possible implementation manner provided based on any one of the first to the fifth possible implementation manners, the displaying a preset personalized setting interface according to the personalized setting instruction includes:

displaying multiple preset personalized setting interfaces according to the personalized setting instruction; and

receiving an interface selection instruction of the terminal, and displaying a personalized setting interface that is selected by the user from the multiple preset personalized setting interfaces.

A person of ordinary skill in the art may understand that all or some of the steps in the methods of the foregoing embodiments may be implemented by a program instructing relevant hardware. The program may be stored in a computer readable storage medium. The storage medium may include: a ROM, a RAM, a magnetic disk, an optical disc, or the like.

The foregoing specifically introduces the to-be-shared interface processing method and the terminal that are provided in the embodiments of the present invention. Although the principles and implementation manners of the present disclosure are described through specific embodiments in this specification, the descriptions of the embodiments are only intended to help understand the method and core ideas of the present disclosure. Meanwhile, a person of ordinary skill in the art may make modifications to the specific implementation manners and application scopes according to the ideas of the present disclosure. To conclude, the content of the specification should not be construed as a limitation to the present disclosure.

1. A to-be-shared interface processing method, comprising:
receiving a personalized setting instruction of a terminal in a first to-be-shared interface, and displaying a preset personalized setting interface according to the personalized setting instruction;
determining, after a message indicating that a user completes content setting in the personalized setting interface is received, that the personalized setting interface in which content setting is completed is a second to-be-shared interface; and
sharing, after a sharing instruction of the terminal is received, the second to-be-shared interface to a location specified by the user;
wherein after the displaying a preset personalized setting interface, the method further comprises:
displaying a preset setting policy, and displaying, according to a setting policy selected by the user, an interface corresponding to the setting policy selected by the user; and
acquiring a picture that is determined by the user in the corresponding interface, and loading the picture to the personalized setting interface.

2. (canceled)

3. The method according to claim 1, wherein the setting policy is indication information selected from an existing picture, and the displaying, according to a setting policy selected by the user, an interface corresponding to the setting policy selected by the user comprises:
displaying an interface of the existing picture according to the indication information selected from the existing picture; and
the acquiring a picture that is determined by the user in the corresponding interface comprises:
acquiring a picture that is selected by the user in the interface of the existing picture.

4. The method according to claim 1, wherein the setting policy is photographing identifier information, and the displaying, according to a setting policy selected by the user, an interface corresponding to the setting policy selected by the user comprises:
displaying a photographing interface according to the photographing identifier information selected by the user; and
the acquiring a picture that is determined by the user in the corresponding interface comprises:
acquiring a picture that is obtained by photographing by the user in the photographing interface.

5. The method according to claim 1, wherein the setting policy is scribble input indication information, and the displaying, according to a setting policy selected by the user, an interface corresponding to the setting policy selected by the user comprises:
displaying a scribble interface according to the scribble input indication information selected by the user; and
the acquiring a picture that is determined by the user in the corresponding interface comprises:
acquiring a picture that is obtained by scribbling by the user in the scribble interface.

6. The method according to claim 1, wherein the displaying a preset personalized setting interface according to the personalized setting instruction comprises:
displaying multiple preset personalized setting interfaces according to the personalized setting instruction; and
receiving an interface selection instruction of the terminal, and displaying a personalized setting interface that is selected by the user from the multiple preset personalized setting interfaces.

7. A terminal, comprising:
a receiving unit, configured to receive a personalized setting instruction of a terminal in a first to-be-shared interface;
a display unit, configured to display a preset personalized setting interface according to the personalized setting instruction received by the receiving unit,
the receiving unit being further configured to receive a message indicating that a user completes content setting in the personalized setting interface;
a determining unit, configured to: after the receiving unit receives the message indicating that the user completes content setting in the personalized setting interface, determine that the personalized setting interface in which content setting is completed is a second to-be-shared interface,
the receiving unit being further configured to receive a sharing instruction of the terminal; and
a sharing unit, configured to: after the receiving unit receives the sharing instruction of the terminal, share the second to-be-shared interface to a location specified by the user;
wherein the display unit is further configured to display a preset setting policy, and display, according to a setting policy selected by the user, an interface corresponding to the setting policy selected by the user; and
the terminal further comprises:
an acquiring unit, configured to acquire a picture that is determined by the user in the corresponding interface displayed by the display unit, and load the picture to the personalized setting interface.

8. (canceled)

9. The terminal according to claim 87, wherein the setting policy is indication information selected from an existing picture, and
the display unit is configured to display an interface of the existing picture according to the indication information selected from the existing picture; and
the acquiring unit is configured to acquire a picture that is selected by the user in the interface of the existing picture.

10. The terminal according to claim 87, wherein the setting policy is photographing identifier information, and
the display unit is configured to display a photographing interface according to the photographing identifier information selected by the user; and
the acquiring unit is configured to acquire a picture that is obtained by photographing by the user in the photographing interface.

11. The terminal according to claim 87, wherein the setting policy is scribble input indication information, and
the display unit is configured to display a scribble interface according to the scribble input indication information selected by the user; and
the acquiring unit is configured to acquire a picture that is obtained by scribbling by the user in the scribble interface.

12. The terminal according to claim 7, wherein
the display unit is configured to display multiple preset personalized setting interfaces according to the personalized setting instruction;
the receiving unit is further configured to receive an interface selection instruction of the terminal; and
the display unit is configured to display, according to the interface selection instruction of the terminal, a personalized setting interface that is selected by the user from the multiple preset personalized setting interfaces.

13. The method according to claim 3, wherein the displaying a preset personalized setting interface according to the personalized setting instruction comprises:
displaying multiple preset personalized setting interfaces according to the personalized setting instruction; and
receiving an interface selection instruction of the terminal, and displaying a personalized setting interface that is selected by the user from the multiple preset personalized setting interfaces.

14. The method according to claim 4, wherein the displaying a preset personalized setting interface according to the personalized setting instruction comprises:
displaying multiple preset personalized setting interfaces according to the personalized setting instruction; and
receiving an interface selection instruction of the terminal, and displaying a personalized setting interface that is selected by the user from the multiple preset personalized setting interfaces.

15. The method according to claim 5, wherein the displaying a preset personalized setting interface according to the personalized setting instruction comprises:
displaying multiple preset personalized setting interfaces according to the personalized setting instruction; and
receiving an interface selection instruction of the terminal, and displaying a personalized setting interface that is selected by the user from the multiple preset personalized setting interfaces.

16. The terminal according to claim 9, wherein
the display unit is configured to display multiple preset personalized setting interfaces according to the personalized setting instruction;
the receiving unit is further configured to receive an interface selection instruction of the terminal; and
the display unit is configured to display, according to the interface selection instruction of the terminal, a personalized setting interface that is selected by the user from the multiple preset personalized setting interfaces.

17. The terminal according to claim 10, wherein
the display unit is configured to display multiple preset personalized setting interfaces according to the personalized setting instruction;
the receiving unit is further configured to receive an interface selection instruction of the terminal; and
the display unit is configured to display, according to the interface selection instruction of the terminal, a personalized setting interface that is selected by the user from the multiple preset personalized setting interfaces.

18. The terminal according to claim 11, wherein
the display unit is configured to display multiple preset personalized setting interfaces according to the personalized setting instruction;
the receiving unit is further configured to receive an interface selection instruction of the terminal; and
the display unit is configured to display, according to the interface selection instruction of the terminal, a personalized setting interface that is selected by the user from the multiple preset personalized setting interfaces.
